(19) United States
(12) Patent Application Publication
(10) Pub. No.: US 2026/0081088 A1
(43) Pub. Date: Mar. 19, 2026

(54) REMOTE CONTROL BREAKERS

(71) Applicant: Schneider Electric USA, Inc., Andover, MA (US)

(72) Inventor: Chad R. Mittelstadt, Cedar Rapids, IA (US)

(73) Assignee: Schneider Electric USA, Inc., Boston, MA (US)

(21) Appl. No.: 18/887,185

(22) Filed: Sep. 17, 2024

(51) Int. Cl. H01H 71/04; H01H 71/70; H01H 77/06

(52) U.S. Cl. CPC H01H 71/04; H01H 71/70; H01H 77/06

(57) ABSTRACT

A circuit breaker includes a breaker body housing a circuit and a controller for controlling the circuit. An internal handle mechanism and breaker mechanism in the breaker body have three states. The three states include an ON state wherein the breaker mechanism is in the closed contact state and the internal handle mechanism is in an ON position, an OFF state in which the breaker mechanism is in the open contact state and the internal handle mechanism is in an OFF position, and a TRIPPED state in which the breaker mechanism is in the open contact state and the internal handle mechanism is in a TRIPPED position. The controller and motor are configured to drive the internal handle mechanism. A lockout mechanism is configured to allow the breaker mechanism to lock the breaker mechanism in the TRIPPED state with a lockout tag in a locked position.

### FIELD

This disclosure relates to circuit breakers, and more particularly to remote controlled circuit breakers.

### BACKGROUND

Traditional motorized circuit breakers, for example, have mechanisms that allow opening of the contacts to open the circuit. However, in returning to the closed state, motorized systems include relatively slow closure which can affect performance negatively (e.g., extended arcing between contacts leading to contact degradation).

Such conventional methods and systems have generally been considered satisfactory for their intended purpose. However, there is still a need in the art for improved circuit breakers. The present disclosure provides a solution for this need.

### SUMMARY

A circuit breaker includes a breaker body housing a circuit and a controller for controlling the circuit. A breaker mechanism is housed in the breaker body, operatively connected to open and close a contact of the circuit to an open contact state and a closed contact state based on commands from the controller. An internal handle mechanism is housed inside the breaker body and is operatively connected to the breaker mechanism. The internal handle mechanism and breaker mechanism in combination have three states. The three states include an ON state wherein the breaker mechanism is in the closed contact state and the internal handle mechanism is in an ON position, an OFF state in which the breaker mechanism is in the open contact state and the internal handle mechanism is in an OFF position, and a TRIPPED state in which the breaker mechanism is in the open contact state and the internal handle mechanism is in a TRIPPED position. The controller is configured to drive the internal handle mechanism to reset the internal handle mechanism and the breaker mechanism from the TRIPPED state to the OFF state, then to drive the internal handle mechanism to the ON state to return the beaker mechanism to the closed circuit state.

The breaker body can include an interface side, a connector side, a first end extending from the connector side to the interface side, and a second end opposite the first end. The breaker body can include a first compartment housing the internal handle mechanism and a second compartment housing the breaker mechanism. The first compartment can be side by side with the second compartment. The first and second compartments can extend between the first end and the second end of the breaker body.

The breaker body can include a user interface side and a connector side opposite the user interface side. The connector side can include a plug-on-neutral connector for connecting to a neutral bus bar and a line connector for connecting to a line bus bar.

The internal handle mechanism can be housed entirely within the breaker body. The internal handle mechanism can include an indicator with indica. The indicia can include a first indicum aligned to be visible through a window of the breaker body with in internal handle mechanism in the ON position, a second indicum aligned to be visible through the window in with the interface side of the breaker body in the OFF position, and a third indicum aligned to be visible through the window with the internal handle mechanism in the TRIPPED position.

A handle of the internal handle mechanism can connect to a movable contact member of the breaker mechanism at a movable pivot point. A toggle spring can connect between a trip lever of the breaker mechanism and the moveable contact member. The toggle spring can be configured to over-center relative to the movable pivot point in motion back and forth between the ON state and the OFF state.

The internal handle mechanism can be configured to drive the breaker mechanism from the open contact state to the closed contact state to transition from the OFF state to the ON state. The internal handle mechanism can be configured to drive the breaker mechanism from the closed contact state to the open contact sate to transition from the ON state to the OFF state.

The breaker mechanism can include a solenoid operatively connected to be controlled by the controller. An armature and yoke member can be biased away from the solenoid and can be operatively connected to be moved toward by the solenoid by activation of the solenoid to reach the TRIPPED state. A trip lever can be mounted to a pivot point in the breaker body, configured to be held by the armature and yoke member in the ON state and in the OFF state, and to be released by the armature and yoke member in the TRIPPED state. A movable contact member can be connected to a handle of the internal handle mechanism at a movable pivot point. A toggle spring can connect between the trip lever and the moveable contact member. The toggle spring can be configured to over-center relative to the movable pivot point in motion back and forth between the ON state and the OFF state. The beaker mechanism can be configured to actuate the internal handle mechanism from the ON state to the TRIPPED state upon a command from the controller detecting a fault in the circuit.

A sensor can be operatively connected to provide feedback to the controller indicative of state of the circuit. The controller can be configured to activate the solenoid to enter the TRIPPED state upon feedback from the sensor indicative of a fault in the circuit. The controller can be configured to activate the solenoid to enter the TRIPPED state and return to the ON state in an absence of feedback from the sensor indicative of a fault in the circuit.

The internal handle mechanism can include a motor operatively connected to be controlled by the controller. A worm gear can be operatively connected to be driven by the motor in rotation about a worm axis. A first gear can be meshed to the worm gear to be driven by the worm gear about a first gear axis. A second gear can be mounted for rotation about the first gear axis. The second gear can be operatively connected to the first gear to be driven by the first gear with a snap action. A handle gear can be fixed for limited rotation relative to the handle of the internal handle mechanism. The handle gear can be configured to drive motion of the moveable contact member of the breaker mechanism by moving the moveable pivot point.

A lockout mechanism can be operatively connected to the breaker body. The lockout mechanism can include a lockout tag mounted to the breaker body. The lockout mechanism can be configured to allow the breaker mechanism and the internal handle mechanism to operate in the ON state, in the OFF state, and in the TRIPPED state with the lockout tag in a normal position relative to the breaker body. The lockout mechanism can be configured to lock the breaker mechanism and the internal handle mechanism in the TRIPPED state with the lockout tag in a locked position relative to the breaker body.

The lockout mechanism can be configured to drive the breaker mechanism and the internal handle mechanism into the TRIPPED state in passing from the normal position to the locked position. The breaker mechanism can include a solenoid operatively connected to be controlled by the controller, and an armature and yoke member biased away from the solenoid and operatively connected to be moved toward by the solenoid by activation of the solenoid to reach the TRIPPED state. The lockout tag can be configured to force the armature and yoke mechanism toward the solenoid to reach the TRIPPED state without activation of the solenoid as the lockout tag moves from the normal position to the locked position.

A switch can be mounted inside the breaker body. The lockout tag can be configured to release the switch in the locked position. The switch can be operatively connected to the controller to input a signal to the controller indicative of the locked position of the lockout tag responsive to the lockout tag triggering the switch. The controller can be configured to deny movement of the motor with the switch released to prevent movement of the breaker mechanism and of the internal handle mechanism to the OFF state or to the ON state.

The lockout tag can include a lock receptacle defined in the lockout tag configured to receive a bolt of a lock. The lockout mechanism can be isolated from the breaker mechanism and from the internal handle mechanism such that the movement of the lockout tag can never trigger the ON state or the OFF state.

A circuit breaker includes a breaker body housing a circuit and a controller for controlling the circuit. A breaker mechanism is housed in the breaker body and is configured to be driven by a motor operatively connected to be controlled by the controller. The breaker mechanism is operatively connected to open and close a contact of the circuit based on commands from the controller to an open contact state and a closed contact state. The breaker mechanism has three states. The three states include an ON state wherein the breaker mechanism is in the closed contact state, an OFF state in which the breaker mechanism is in the open contact state, and a TRIPPED state in which the breaker mechanism is in the open contact state. The controller and motor are configured to drive the breaker mechanism to reset the breaker mechanism from the TRIPPED state to the OFF state, then to drive the breaker mechanism to the ON state to return the beaker mechanism to the closed circuit state. A lockout mechanism is operatively connected to the breaker body. The lockout mechanism includes a lockout tag mounted to the breaker body. The lockout mechanism is configured to allow the breaker mechanism to operate in the ON state, in the OFF state, and in the TRIPPED state with the lockout tag in a normal position relative to the breaker body. The lockout mechanism is configured to lock the breaker mechanism in the TRIPPED state with the lockout tag in a locked position relative to the breaker body.

The lockout mechanism can be configured to drive the breaker mechanism into the TRIPPED state in passing from the normal position to the locked position. The breaker mechanism can include a solenoid operatively connected to be controlled by the controller, and an armature and yoke member biased away from the solenoid and operatively connected to be moved toward by the solenoid by activation of the solenoid to reach the TRIPPED state. The lockout tag can be configured to force the armature and yoke mechanism toward the solenoid to reach the TRIPPED state without activation of the solenoid as the lockout tag moves from the normal position to the locked position.

A switch can be mounted inside the breaker body. The lockout tag can be configured to release the switch in the locked position. The switch can be operatively connected to the controller to input a signal to the controller indicative of the locked position of the lockout tag responsive to the lockout tag triggering the switch. The controller can be configured to deny movement of the motor with the switch released to prevent movement of the breaker mechanism to the OFF state or to the ON state. The lockout tag can include a lock receptacle defined in the lockout tag configured to receive a bolt of a lock. The lockout mechanism can be isolated from the breaker mechanism such that the movement of the lockout tag can never trigger the ON state or the OFF state.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a side elevation view of an embodiment of a circuit breaker constructed in accordance with the present disclosure, showing the plug-on-neutral connector for connecting to a neutral bus bar;

FIG. 2 is a cross-sectional end elevation view of the circuit breaker of FIG. 1, showing the internal handle mechanism and the breaker mechanism;

FIG. 3 is a perspective view of the circuit breaker of FIG. 1, showing the interface side with the lockout tag in the unlocked position;

FIG. 4 is a perspective view of the circuit breaker of FIG. 1, showing the lockout tag in the locked position;

FIG. 5 is a perspective view of the circuit breaker of FIG. 1, showing a lock bolting the lockout tag in the locked position;

FIG. 6 is a cross-sectional side elevation view of the circuit breaker of FIG. 1, showing the controller and other internal components;

FIG. 7 is a cross-sectional side-elevation view of the circuit breaker of FIG. 1, showing the moveable pivot connecting the internal handle mechanism to the breaker mechanism as well as the line side connector for connecting to a line bus bar;

FIG. 8 is a cross-sectional side-elevation view of the circuit breaker of FIG. 1, showing the internal handle mechanism;

FIG. 9 is a perspective view of a portion of the internal handle mechanism of FIG. 8, showing the worm gear, the first and second gears, and the handle gear;

FIG. 10 is a cross-sectional perspective view of the portion of the internal handle mechanism of FIG. 9, showing the spring compartment between the first and second gears;

FIG. 11 is an exploded perspective view of the first and second gears of FIG. 10, showing the springs in the spring compartment;

FIG. 12 is a graph showing energy stored and second gear rotation as a function of first gear rotation for the snap action of the first and second gears;

FIG. 13 is a side elevation view of a portion of the internal handle mechanism of FIG. 8, showing the internal handle;

FIG. 14 is a side elevation view of the portion of the internal handle mechanism, showing the side reverse from that shown in FIG. 13;

FIG. 15 is a perspective view of the portion of the internal handle mechanism of FIG. 13, showing the indicia for the ON, OFF and TRIPPED states;

FIG. 16 is a perspective view of a portion of the circuit breaker of FIG. 1, showing the window in the interface side of the breaker body;

FIG. 17 is a cross-sectional perspective view of the portion of the circuit breaker of FIG. 16, showing one indicum of the internal handle aligned to be visible through the window;

FIG. 18 is a cross-sectional side elevation view of the circuit breaker of FIG. 1, schematically showing movement of the internal handle mechanism when going to the ON position;

FIG. 19 is a cross-sectional side elevation view of the circuit breaker of FIG. 18, schematically showing movement of the breaker mechanism when going to the ON position;

FIG. 20 is a cross-sectional side elevation view of the circuit breaker of FIG. 1, schematically showing movement of the internal handle mechanism when going to the OFF (or reset) position;

FIG. 21 is a cross-sectional side elevation view of the circuit breaker of FIG. 1, schematically showing movement of the breaker mechanism when going to the OFF (or reset) position;

FIG. 22 is a cross-sectional side elevation view of the circuit breaker of FIG. 1, schematically showing the internal handle mechanism and the breaker mechanism in the ON state;

FIG. 23 is a cross-sectional side elevation view of the breaker mechanism of FIG. 22, schematically showing movement of the internal handle mechanism and the breaker mechanism when going to the TRIPPED state by command of the controller;

FIG. 24 is a cross-sectional side elevation view of a portion of the circuit breaker of FIG. 1, schematically indicating movement of the lockout tag from the unlocked toward the locked position; and

FIG. 25 is a cross-sectional side elevation view of the portion of the circuit breaker of FIG. 24, schematically indicating movement of the breaker mechanism with the tag going to the locked position.

### DETAILED DESCRIPTION OF THE PREFERRED EMBODIMENTS

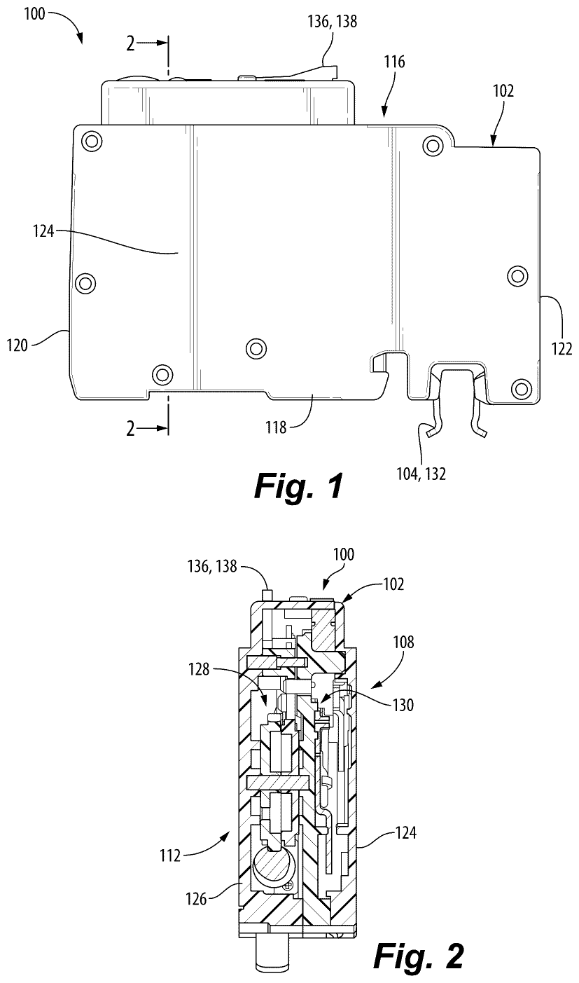

Reference will now be made to the drawings wherein like reference numerals identify similar structural features or aspects of the subject disclosure. For purposes of explanation and illustration, and not limitation, a partial view of an embodiment of a circuit breaker in accordance with the disclosure is shown in FIG. 1 and is designated generally by reference character 100. Other embodiments of systems in accordance with the disclosure, or aspects thereof, are provided in FIGS. 2-25, as will be described. The systems and methods described herein can be used to provide for remote control of a circuit breaker such as a miniature circuit breaker (MCB) used in residential breaker boxes and the like.

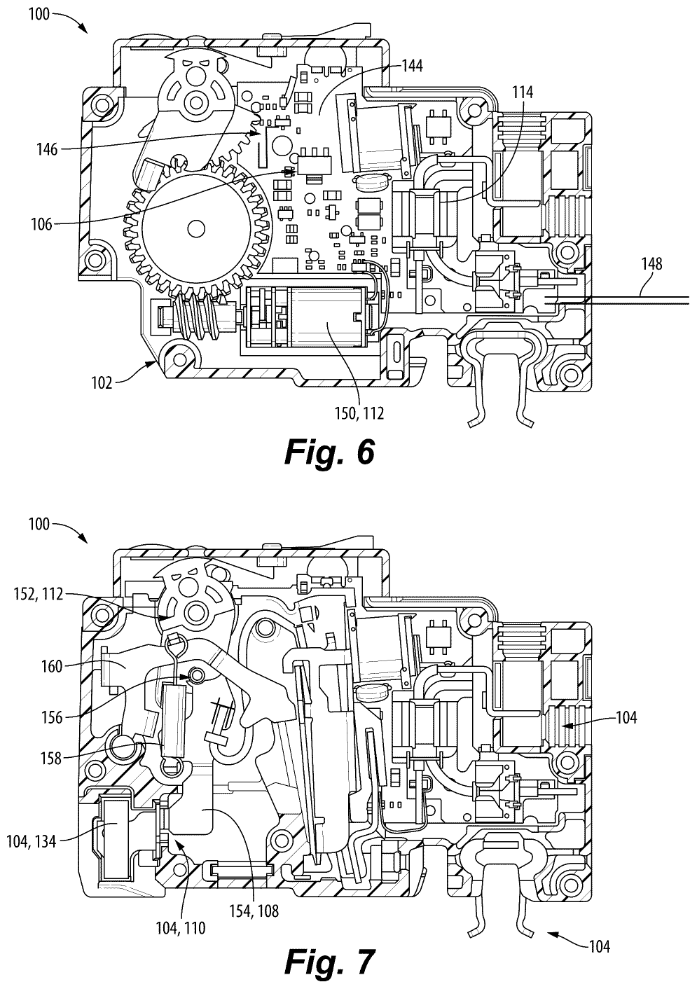

The circuit breaker 100 includes a breaker body 102 housing a circuit 104 (labeled in FIG. 7) and a controller 106 for controlling the circuit 104. As shown in FIG. 2, a breaker mechanism 108 is housed in the breaker body 102, operatively connected to open and close a contact 110 (labeled in FIG. 7) of the circuit 104 to an open contact state and a closed contact state based on commands from the controller 106. A remote controlled internal handle mechanism 112 is housed inside the breaker body 102 and is operatively connected to the breaker mechanism 108. The internal handle mechanism 112 and breaker mechanism 108 in combination have three states. The first of the three states include an ON state wherein the breaker mechanism 108 is in the closed contact state (as shown in FIG. 7) and the internal handle mechanism 112 is in an ON position. The second of the three states is an OFF state in which the breaker mechanism 108 is in the open contact state (as shown in FIG. 21) and the internal handle mechanism 112 is in an OFF position. The third of the three states is a TRIPPED state in which the breaker mechanism 108 is in the open contact state and the internal handle mechanism 112 is in a TRIPPED position, as shown in FIG. 23. The controller 106 is configured to drive the internal handle mechanism 112 to reset the internal handle mechanism 112 and the breaker mechanism 108 from the TRIPPED state to the OFF state, then to drive the internal handle mechanism 112 to the ON state to return the beaker mechanism 108 to the closed circuit state, e.g. after the controller 106 detects via sensors 114 labeled in FIG. 6, e.g. current sensors operatively connected to sense current in the circuit 104, that the circuit 104 is clear of faults.

The breaker body 102 includes an interface side 116, a connector side 118 opposite the interface side 116, a first end 120 extending from the connector side 118 to the interface side 116, and a second end 122 opposite the first end 120. The connector side 118 includes a plug-on-neutral connector 132 of the circuit 104 for connecting to a neutral bus bar and a line connector 134 of the circuit 104 (labeled in FIG. 7) for connecting to a line bus bar. Those skilled in the art will readily appreciate that the plug-on-neutral connector 130 can be optionally omitted for applications where there is no neutral bus bar.

As shown in FIG. 2, two opposed lateral sides 124, 126 of the breaker body 102 form an enclosure with sides 116, 118 and ends 120, 122 enclosing the controller 106 (labeled in FIG. 6), the breaker mechanism 108, the internal handle mechanism 112, and internal portions of the circuit 104, labeled in FIG. 7. The breaker body 102 includes a first compartment 128 housing the internal handle mechanism 112 and a second compartment 130 housing the breaker mechanism 108. The first compartment 128 is side by side with the second compartment 112 as shown in the cross-section of FIG. 2, i.e., the compartments 128, 130 each extend substantially from the first end 120 to the second end 122 and from the connector side 118 to the interface side, but the first compartment 128 is bounded by only side 126 of the two lateral sides 124, 126, and the second compartment 130 is bounded only by lateral side 124 of the two lateral sides 124, 126.

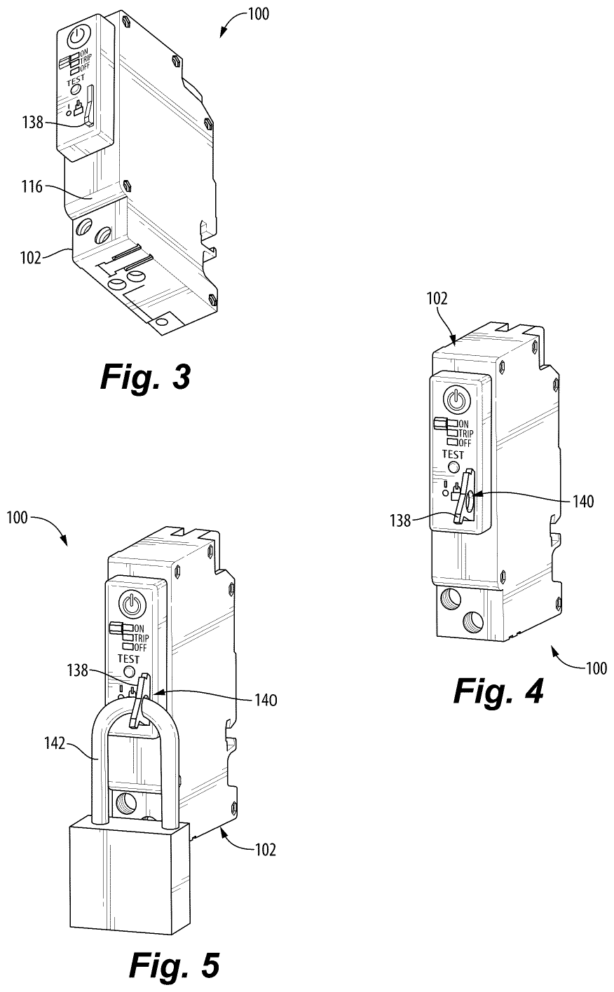

There is also a lockout mechanism 136 for locking the breaker mechanism 108 and the internal handle mechanism 112 in the TRIPPED state. A lockout tag 138 of the lockout mechanism 136 is accessible to users from the interface side 116 of the breaker body. FIG. 3 shows the lockout tag 138 in the unlocked position, which allows normal operation of the breaker mechanism 108 and the internal handle mechanism 112 of FIG. 2. FIG. 4 shows the lockout tag 138 extended to the locked position, as when a user wants to lock the circuit breaker 102. This locked position of the lockout tag 138 in FIG. 4 reveals a lock receptacle 140 configured to receive the bolt of a lock 142, as shown in FIG. 5.

With reference now to FIG. 6, the controller 106 can be in any suitable form such as a microcontroller on a printed circuit board assembly (PCBA) 144. PCBA 114 can also include components 146 for wireless connections, such as a wireless chipset and antenna, and/or components 148 for wired connections such as USB connectors or the like. The components 146, 148 can convey user commands from wired or wireless communication to the controller 106 for changing the state of the internal handle mechanism 112 and the breaker mechanism 108. In the case of component 148 for wired connection, it can also convey power to the controller 106 and motor 150 of the internal handle mechanism 112 which will is further described below.

Referring now to FIG. 7, a handle 152 of the internal handle mechanism 112 connects to a movable contact member 154 of the breaker mechanism 108 at a movable pivot point. A toggle spring 158 connects between a trip lever 160 of the breaker mechanism 108 and the moveable contact member 154. The toggle spring 158 is configured to move, stretching and contracting over-center relative to the movable pivot point 156 in motion back and forth between the ON state and the OFF state, which are further described below.

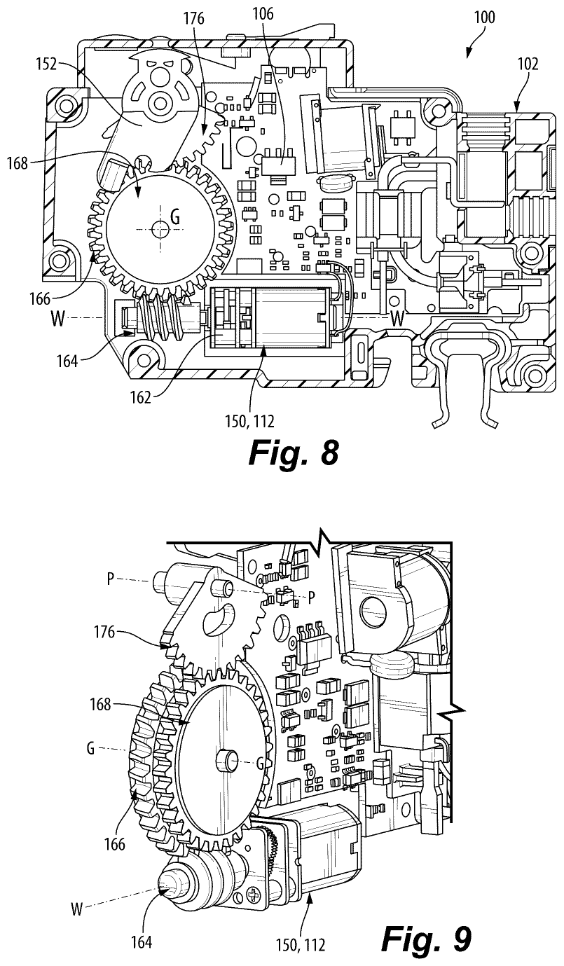

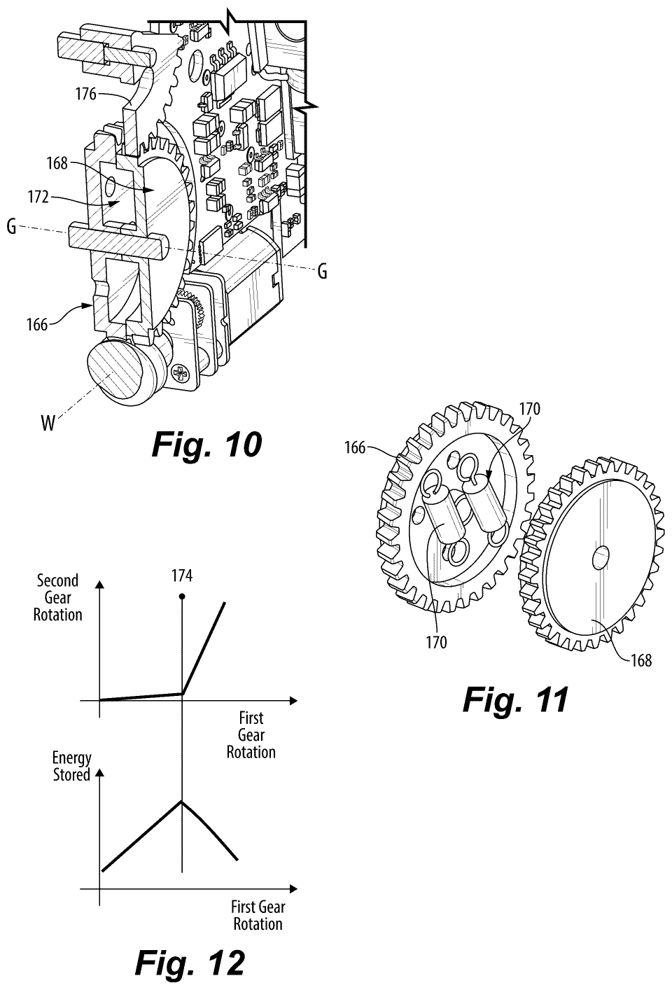

With reference now to FIG. 8, the internal handle mechanism 112 is configured to drive the breaker mechanism 108 (labeled in FIG. 2) from the open contact state to the closed contact state to transition the circuit breaker 102 from the OFF state to the ON state. The internal handle mechanism 112 is also configured to drive the breaker mechanism 108 from the closed contact state to the open contact sate to transition from the ON state to the OFF state. The internal handle mechanism includes the motor 112 operatively connected to be controlled by the controller 106. The motor includes an optional gear transmission 162, e.g. for gear reduction. A worm gear 164 is operatively connected, e.g. directly or through the optional transmission 162, to be driven by the motor 150 in rotation about a worm axis W. A first gear 166, e.g. a spur gear or pinion gear, is meshed to the worm gear 164 to be driven by the worm gear 164 about a first gear axis G (also shown in FIG. 9) that is perpendicular to the worm axis W. A second gear 168 is mounted for rotation about the first gear axis G, e.g. the same axis G as the first gear 166. The second gear 168 is smaller in diameter than the first gear 166. The second gear 168 operatively connected to the first gear 166 to be driven by the first gear 166 with a snap action. The snap action is achieved by one or more springs 170 (labeled in FIG. 11), or equivalent energy storage members, inside a spring compartment 172 (labeled in FIG. 10) enclosed by the first and second gears 166, 168. The snap action of the second gear 168 is indicated in the graphs of FIG. 12, where an inflection or over-center point 174 is indicated in the curves for energy stored and second gear rotation as a function of first gear rotation. The over-center point 174 is a point where the second gear 168 of FIG. 11 moves rapidly in a snap action. This same snap action happens in both clockwise and counter-clockwise movement of the gears 166, 168 for going to the ON state and to the OFF state as further described below.

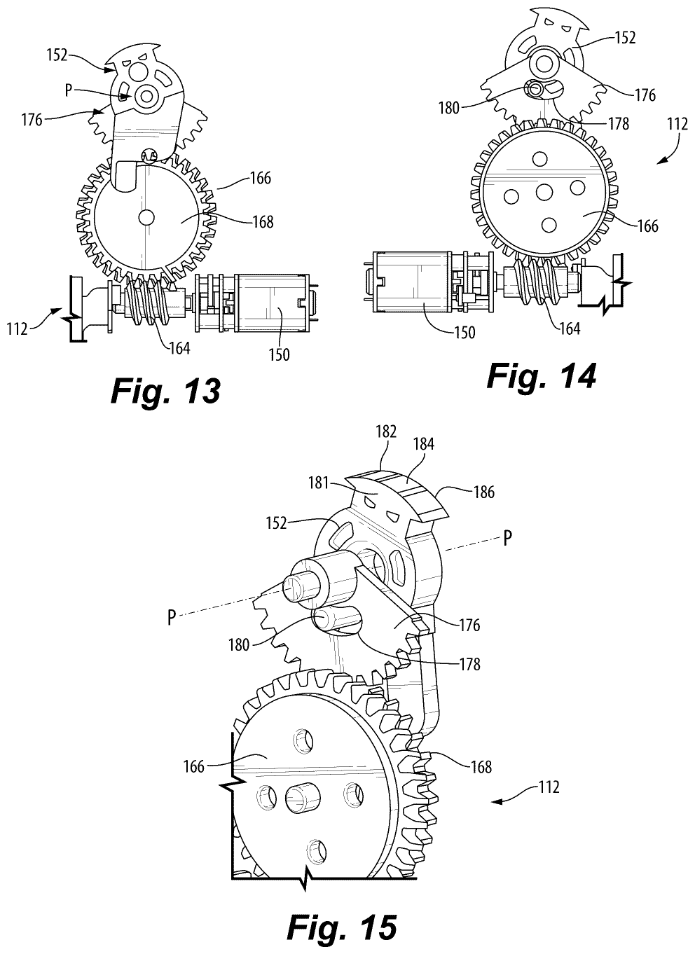

With reference now to FIG. 13, a handle gear 176 is fixed for limited rotation relative to the handle 152 of the internal handle mechanism 112. The handle gear 176 is configured to drive motion of the moveable contact member 154 of the breaker mechanism 108 by moving the moveable pivot point 156 (see labels in FIG. 6) that connects the handle 152 to the moveable contact member 154. The controller 106 (labeled in FIGS. 8-9) runs the motor 150 in response to user input, or input from an automated system, or the like. As shown in FIG. 14, there is a slot 178 in handle gear to allow the limited independent motion of the handle 152 and the handle gear 176 depending on position of the pin 180 of the handle 152 in the slot 128. The gears 166, 168 are coupled via spring elements 170 as described above, that store energy from relative movement between gears 166, 168. The pin 180 and slot 178 allow for snap action of the breaker mechanism 108 and handle 152 going to the TRIPPED state independent the position of the motor 150 or work 164. In this way, the internal handle mechanism can drive the breaker mechanism 108 much as would a user applying force through an exterior facing handle.

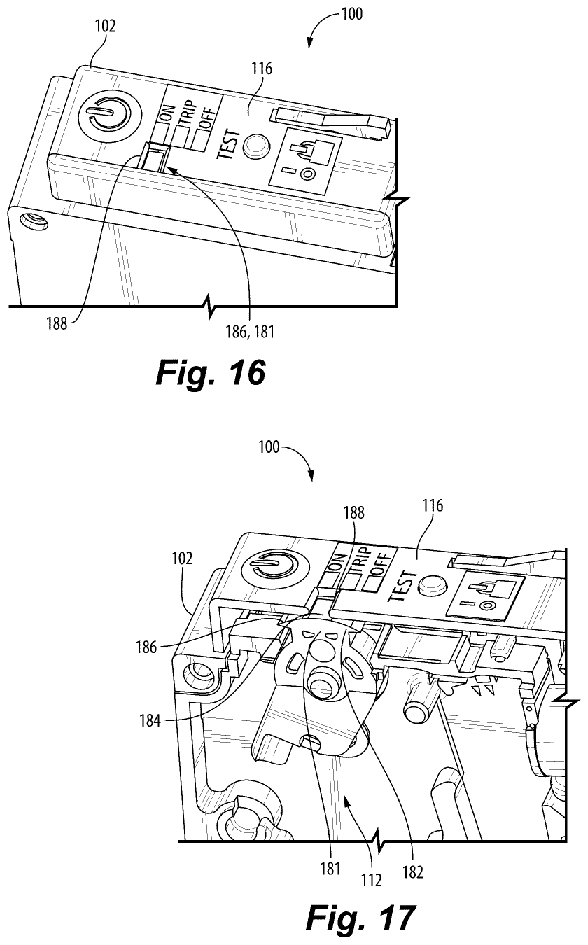

As shown in FIG. 15, the handle 152 includes and indicator 181 with three indicia 182, 184, 186 for indicating the ON, TRIPPED, and OFF, states respectively. As shown in FIG. 16 the internal handle mechanism 112 (labeled in FIG. 17) is housed entirely within the breaker body 102 and only the indicator 181 is visible through a window 188 in the interface side 116 of the breaker body 102. The indicia include a first indicum 182 aligned to be visible through a window 188 of the breaker body 102 with in internal handle mechanism 112 in the ON position, a second indicum 186 aligned to be visible through the window 188 in with the interface side 116 of the breaker body in the OFF position, and a third indicum 184 aligned to be visible through the window 188 with the internal handle mechanism 112 in the TRIPPED position.

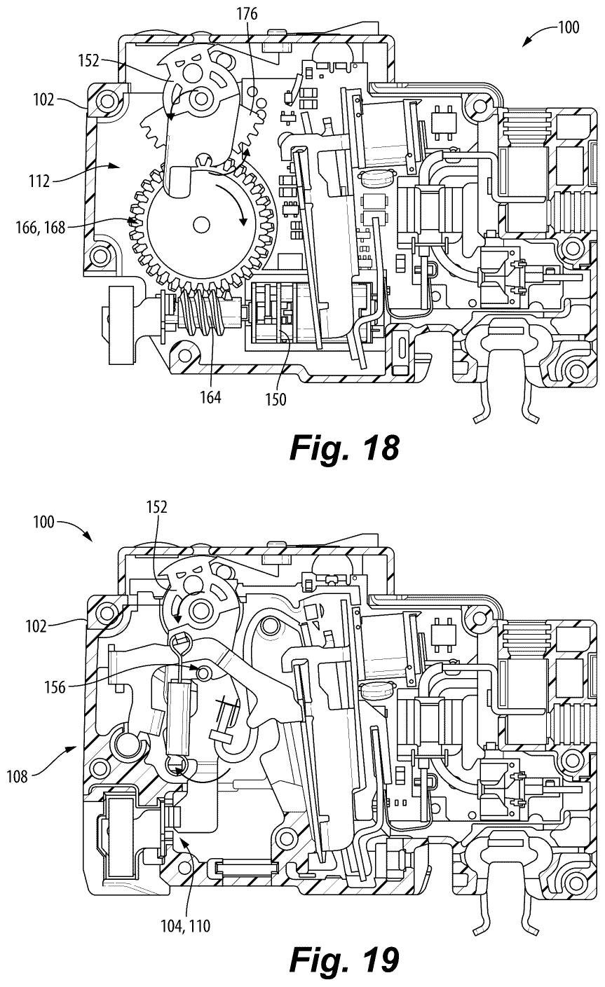

With reference now to FIGS. 18 and 19, the motions of the internal switch mechanism 112 and the breaker mechanism 108 going to the ON position are described, wherein FIG. 18 shows the motions of the internal switch mechanism 112 and FIG. 19 shows the motions of the breaker mechanism 108, wherein motion is indicated schematically with rotation arrows. As the motor 150 turns the worm gear 164, the work gear 164 drives the gears 166, 168, which in turn the handle gear 176, and with snap action, the handle 152. With reference to FIG. 19, the snap action of the handle 152 moves the moveable pivot point 156 that connects the handle 152 to the contact member 154 of the breaker mechanism 108 to close the contacts 110 of the circuit 104.

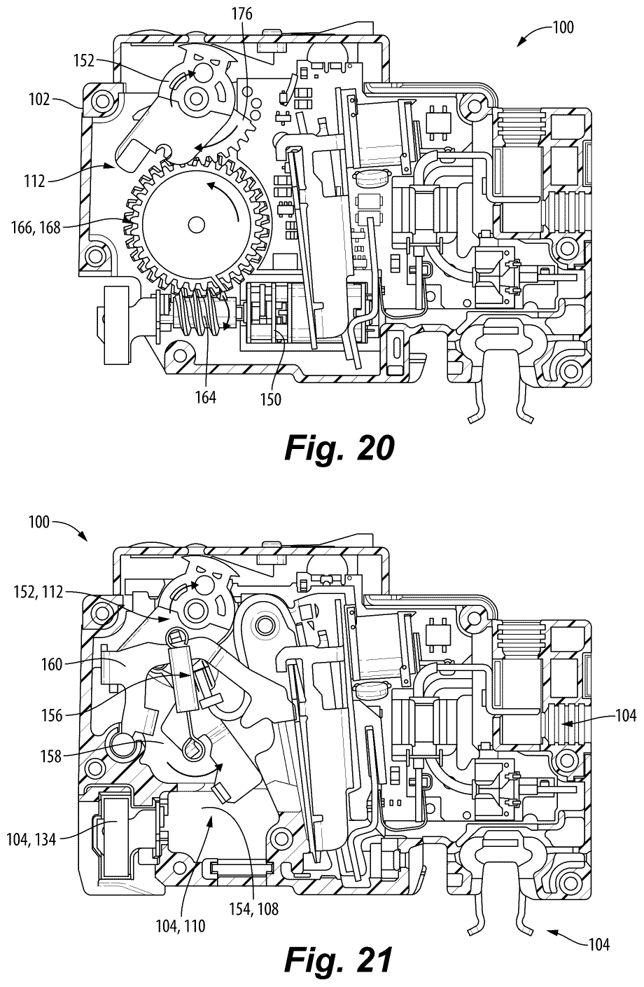

With reference now to FIGS. 20 and 21, the motions of the internal switch mechanism 112 and the breaker mechanism 108 going to the OFF or RESET position are described, wherein FIG. 20 shows the motions of the internal switch mechanism 112 and FIG. 21 shows the motions of the breaker mechanism 108, wherein motion is indicated schematically with rotation arrows. For the internal handle mechanism in FIG. 20, the rotation arrows for going to the OFF or RESET position are opposite those shown in FIG. 18 for going to the ON position, i.e. the motor 150 rotates the opposite direction for going to the OFF or RESET position as it does for going to the ON position. This rotates the contact member 154 of the breaker mechanism in a direction that opens the contacts 110 of the circuit 110. This same motion can be used whether going from the ON position to the OFF position, or goring from the TRIPPED position to the OFF position to reset after at fault.

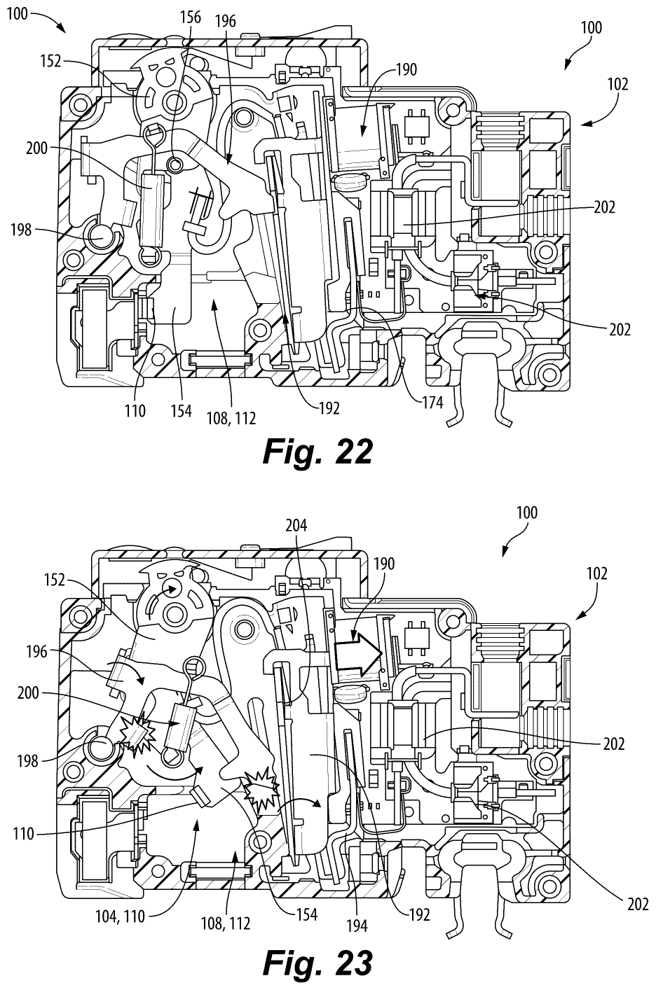

With reference now to FIGS. 22 and 23, the motions of the breaker mechanism 108 and the internal switch mechanism 112 are shown. As shown in FIG. 22, the breaker mechanism 108 includes a solenoid 190 operatively connected to be controlled by the controller 106 (labeled in FIG. 6). An armature and yoke member 192 is biased away from the solenoid 190 by a biasing member 194 and is operatively connected to be moved toward by the solenoid 190 by activation of magnetic forces (indicated by the large arrow in FIG. 23) in the solenoid 190 to reach the TRIPPED state. A trip lever 196 is mounted to a pivot point 198 in the breaker body 102. The trip lever 196 is configured to be held by the armature and yoke member 192 in the ON state and in the OFF state, and to be released by the armature and yoke member 192 in the TRIPPED state. The movable contact member 154 is connected to the handle 152 of the internal handle mechanism 112 at the movable pivot point 156. A toggle spring 200 connects between the trip lever 196 and the moveable contact member 154. The toggle spring 200 is configured to over-center relative to the movable pivot point 156 in motion back and forth between the ON state and the OFF state. In other words, the moveable pivot point 156 moves across a line between the end points of the toggle spring 200, where the tension on the toggle spring 200 is greatest, when moving between the ON and OFF states. The beaker mechanism 108 is configured to actuate the internal handle mechanism 112 from the ON state to the TRIPPED state upon a command from the controller 106 (labeled in FIG. 6) detecting a fault in the circuit 104, as the breaker mechanism itself actuates from the closed contact state to the open contact state.

Sensors 202 are operatively connected to provide feedback to the controller 106 (labeled in FIG. 6) indicative of state of the circuit 106, e.g. the one or more sensors 202 can be current sensors operatively connected to detect electrical current passing through the circuit 104. The controller 106 (labeled in FIG. 6) is configured to activate the solenoid 190 when in the ON state in FIG. 22 to enter the TRIPPED state in FIG. 23 upon feedback from the sensor 202 indicative of a fault in the circuit 104. Activation of the solenoid 190 generates an electromagnetic force, indicated by the large arrow in FIG. 23, which pulls the yoke and armature member 192 against the bias of the biasing member 194 to the position shown in FIG. 23. This clears the trip lever 196 from being held in the latch area 204 of the yoke and armature member 194. Freed from the latch area 204, the trip lever 196 pivots downward under the spring action of the toggle spring 200, and as the trip lever 196 moves, it moves the end point of the toggle spring 200 attached to the trip lever 196. This moves the toggle spring over-center relative to the moveable pivot point 156, so the toggle spring pulls the moveable contact member 154 to the position shown in Fig. 23, opening the contacts 110 to break the circuit 104. The controller 106 (labeled in FIG. 6) is configured to activate the solenoid 190 to enter the TRIPPED state. The controller 106 (labeled in FIG. 6) is also configured to use the motor 150 to return to the ON state via the OFF or RESET state as described above with reference to FIGS. 18-21, in an absence of feedback from the sensor 202 indicative of a fault in the circuit 104.

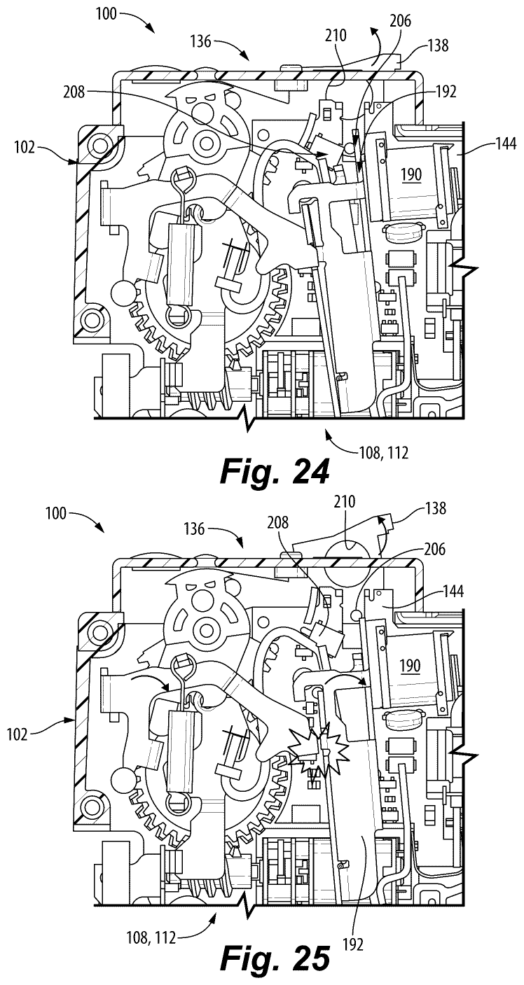

With reference now to FIGS. 24 and 25, the lockout mechanism 136 is operatively connected to the breaker body 102. The lockout mechanism 136 includes a lockout tag 138 pivotably mounted to the breaker body 102. The lockout mechanism 136 is configured to allow the breaker mechanism 108 and the internal handle mechanism 112 to operate in the ON state, in the OFF state, and in the TRIPPED state with the lockout tag 138 in a normal position, shown in FIG. 24, relative to the breaker body 102. The lockout mechanism 136 is configured to lock the breaker mechanism 108 and the internal handle mechanism 112 in the TRIPPED state with the lockout tag 138 in a locked position relative to the breaker body 102, as shown in FIG. 25.

When a user pulls the lockout tag 138 upward as indicated in FIG. 25, the lockout mechanism 136 is configured to drive the breaker mechanism 108 and the internal handle mechanism 112 into the TRIPPED state in passing from the normal position of FIG. 24 to the locked position of FIG. 25. The lockout tag 138 is configured to force the armature and yoke member 192 toward the solenoid 190 to reach the TRIPPED state without activation of the solenoid 190 as the lockout tag 138 moves from the normal position to the locked position. A lock pin 206 pushes and slides along the yoke and armature member 192 to force the yoke and armature member 192 into the TRIPPED and locked position shown in FIG. 25.

A switch 208, e.g. a microswitch on the PCBA 144, is mounted inside the breaker body 102. The lockout tag 138 is configured to release the switch 208 in the locked position of FIG. 25, and to press the switch 208 in the normal, unlocked position of FIG. 24. The switch 208 is operatively connected to the controller 106 (labeled in FIG. 6) through the PCBA 144 to input a signal to the controller 106 indicative of the locked position of the lockout tag 138 responsive to whether or not the lockout tag 138 is triggering or releasing the switch 208. The controller 106 (labeled in FIG. 6) is configured to deny movement of the motor 150 (labeled in FIG. 6) with the switch 208 released to prevent movement of the breaker mechanism 108 and of the internal handle mechanism 112 to the OFF state or to the ON state until the lockout tag 138 is returned to pressing the switch 208 as shown in FIG. 4, indicating the unlocked state.

The lockout tag 138 includes a lock receptacle 210, e.g. a bore, defined in the lockout tag 138 configured to receive a bolt 142 of a lock, such as a padlock or the like, as shown in FIG. 5. Pulling the lockout tag 138 out as shown in FIG. 25 puts the circuit breaker 100 in the TRIPPED state, and the bolt 142 (shown in FIG. 5) of the lock must be removed and the lockout tag 138 must then be moved back to the normal position shown in FIG. 24 before resetting the circuit breaker 100. The lockout mechanism 136 is isolated from the breaker mechanism 108 and from the internal handle mechanism 112 such that the movement of the lockout tag 138 can never trigger the ON state or the OFF state, i.e. the lockout tag 138 does not kinematically operate as handle-there is no external handle on the circuit breaker 100 for manual operation of the internal handle mechanism 112.

Systems and methods as disclosed herein can provide potential benefits including the following. The systems and methods disclosed herein provide for remote-controlled movement of the breaker mechanism. Commands to open and close and reset the breaker can be sent via the cloud through a physical connection or through wireless. A microcontroller manages the command to action of the motor via a driver.

Fast contact opening of less than 20 ms can be achieved with the trip solenoid. There is an ability to mechanically reset after tripping, including any traditional breaker defined tripping faults like ground fault, arc fault, overload, short circuits, or the like. Similarly, resetting after “pre-tripping” can be just before Codes and Standards (C&S) defined protection trip thresholds, before the fault becomes a defined fault per C&S. Similar resetting can be provided to reset from trip states caused by non-faults. Some examples of functions include breaker full auto-monitoring and self-testing including the full trip chain with solenoid and mechanism actuation, 2) sub 20 ms ultra-fast load shedding due to seamless transition or Power Control System requests, and 3) reset after an over the air update functional confirmation test.

Since there is a built in, integrated lock-off that puts breaker mechanism into tripped state and prevents motor operation, designers no longer need to block external handle. New user interfaces are accommodated without an external handle taking valuable real-estate for indicators or markings. Opening and closing of mechanism is only dependent on internal mechanism and not on external human operation, so there can be less misuse like excess handle force or “teasing” of handle. Full opening of the contacts is possible even in remote-controlled modes. The breaker mechanism, PCBA space, and internal handle mechanism, can all be made narrow enough to fit in traditional breaker envelopes. The stored energy internal handle mechanism having multiple gear sets between motor and handle can be tuned to get snap action from energy storage.

The methods and systems of the present disclosure, as described above and shown in the drawings, provide for remote control of a circuit breaker such as a miniature circuit breaker (MCB) used in residential breaker boxes and the like. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A circuit breaker comprising:
a breaker body housing a circuit and a controller for controlling the circuit;
a breaker mechanism housed in the breaker body, operatively connected to open and close a contact of the circuit to an open contact state and a closed contact state based on commands from the controller; and
an internal handle mechanism housed inside the breaker body and operatively connected to the breaker mechanism, wherein the internal handle mechanism and breaker mechanism in combination have three states including:
an ON state wherein the breaker mechanism is in the closed contact state and the internal handle mechanism is in an ON position,
an OFF state in which the breaker mechanism is in the open contact state and the internal handle mechanism is in an OFF position,
and a TRIPPED state in which the breaker mechanism is in the open contact state and the internal handle mechanism is in a TRIPPED position, wherein the controller is configured to drive the internal handle mechanism to reset the internal handle mechanism and the breaker mechanism from the TRIPPED state to the OFF state, then to drive the internal handle mechanism to the ON state to return the beaker mechanism to the closed circuit state.

2. The circuit breaker as recited in claim 1, wherein the breaker body includes an interface side, a connector side, a first end extending from the connector side to the interface side, and a second end opposite the first end, wherein the breaker body includes a first compartment housing the internal handle mechanism and a second compartment housing the breaker mechanism, wherein the first compartment is side by side with the second compartment, wherein the first and second compartments extend between the first end and the second end of the breaker body.

3. The circuit breaker as recited in claim 1, wherein the breaker body includes a user interface side and a connector side opposite the user interface side, wherein the connector side includes a plug-on-neutral connector for connecting to a neutral bus bar and a line connector for connecting to a line bus bar.

4. The circuit breaker as recited in claim 1, wherein the internal handle mechanism is housed entirely within the breaker body, wherein the internal handle mechanism includes an indicator with indica including:
a first indicum aligned to be visible through a window of the breaker body with in internal handle mechanism in the ON position,
a second indicum aligned to be visible through the window in with the interface side of the breaker body in the OFF position, and
a third indicum aligned to be visible through the window with the internal handle mechanism in the TRIPPED position.

5. The circuit breaker as recited in claim 1, wherein a handle of the internal handle mechanism connects to a movable contact member of the breaker mechanism at a movable pivot point, wherein a toggle spring connects between a trip lever of the breaker mechanism and the moveable contact member, wherein the toggle spring is configured to over-center relative to the movable pivot point in motion back and forth between the ON state and the OFF state.

6. The circuit breaker as recited in claim 1, wherein the internal handle mechanism is configured to drive the breaker mechanism from the open contact state to the closed contact state to transition from the OFF state to the ON state, and wherein the internal handle mechanism is configured to drive the breaker mechanism from the closed contact state to the open contact sate to transition from the ON state to the OFF state.

7. The circuit breaker as recited in claim 6, wherein the breaker mechanism includes:
a solenoid operatively connected to be controlled by the controller;
an armature and yoke member biased away from the solenoid and operatively connected to be moved toward by the solenoid by activation of the solenoid to reach the TRIPPED state;
a trip lever mounted to a pivot point in the breaker body, configured to be held by the armature and yoke member in the ON state and in the OFF state, and to be released by the armature and yoke member in the TRIPPED state;
a movable contact member connected to a handle of the internal handle mechanism at a movable pivot point; and
a toggle spring connecting between the trip lever and the moveable contact member, wherein the toggle spring is configured to over-center relative to the movable pivot point in motion back and forth between the ON state and the OFF state, wherein the beaker mechanism is configured to actuate the internal handle mechanism from the ON state to the TRIPPED state upon a command from the controller detecting a fault in the circuit.

8. The circuit breaker as recited in claim 7, further comprising a sensor operatively connected to provide feedback to the controller indicative of state of the circuit, wherein the controller is configured to activate the solenoid to enter the TRIPPED state upon feedback from the sensor indicative of a fault in the circuit, and wherein the controller is configured to activate the solenoid to enter the TRIPPED state and return to the ON state in an absence of feedback from the sensor indicative of a fault in the circuit.

9. The circuit breaker as recited in claim 8, wherein the internal handle mechanism includes:
a motor operatively connected to be controlled by the controller,
a worm gear operatively connected to be driven by the motor in rotation about a worm axis;
a first gear meshed to the worm gear to be driven by the worm gear about a first gear axis;
a second gear mounted for rotation about the first gear axis, wherein the second gear is operatively connected to the first gear to be driven by the first gear with a snap action; and
a handle gear fixed for limited rotation relative to the handle of the internal handle mechanism, wherein the handle gear is configured to drive motion of the moveable contact member of the breaker mechanism by moving the moveable pivot point.

10. The circuit breaker as recited in claim 1, further comprising a lockout mechanism operatively connected to the breaker body, wherein the lockout mechanism includes a lockout tag mounted to the breaker body,
wherein the lockout mechanism is configured to allow the breaker mechanism and the internal handle mechanism to operate in the ON state, in the OFF state, and in the TRIPPED state with the lockout tag in a normal position relative to the breaker body, and
wherein the lockout mechanism is configured to lock the breaker mechanism and the internal handle mechanism in the TRIPPED state with the lockout tag in a locked position relative to the breaker body.

11. The circuit breaker as recited in claim 10, wherein the lockout mechanism is configured to drive the breaker mechanism and the internal handle mechanism into the TRIPPED state in passing from the normal position to the locked position.

12. The circuit breaker as recited in claim 11, wherein the breaker mechanism includes:
a solenoid operatively connected to be controlled by the controller; and
a armature and yoke member biased away from the solenoid and operatively connected to be moved toward by the solenoid by activation of the solenoid to reach the TRIPPED state, wherein the lockout tag is configured to force the armature and yoke mechanism toward the solenoid to reach the TRIPPED state without activation of the solenoid as the lockout tag moves from the normal position to the locked position.

13. The circuit breaker as recited in claim 12, further comprising a switch mounted inside the breaker body, wherein the lockout tag is configured to release the switch in the locked position, and wherein the switch is operatively connected to the controller to input a signal to the controller indicative of the locked position of the lockout tag responsive to the lockout tag triggering the switch, wherein the controller is configured to deny movement of the motor with the switch released to prevent movement of the breaker mechanism and of the internal handle mechanism to the OFF state or to the ON state.

14. The circuit breaker as recited in claim 10, wherein the lockout tag includes a lock receptacle defined in the lockout tag configured to receive a bolt of a lock.

15. The circuit breaker as recited in claim 10, wherein the lockout mechanism is isolated from the breaker mechanism and from the internal handle mechanism such that the movement of the lockout tag can never trigger the ON state or the OFF state.

16. A circuit breaker comprising:
a breaker body housing a circuit and a controller for controlling the circuit;
a breaker mechanism housed in the breaker body configured to be driven by a motor operatively connected to be controlled by the controller, wherein the breaker mechanism is operatively connected to open and close a contact of the circuit based on commands from the controller to an open contact state and a closed contact state, wherein the breaker mechanism has three states including:
an ON state wherein the breaker mechanism is in the closed contact state;
an OFF state in which the breaker mechanism is in the open contact state; and
a TRIPPED state in which the breaker mechanism is in the open contact state;
wherein the controller and motor are configured to drive the breaker mechanism to reset the breaker mechanism from the TRIPPED state to the OFF state, then to drive the breaker mechanism to the ON state to return the beaker mechanism to the closed circuit state; and
a lockout mechanism operatively connected to the breaker body, wherein the lockout mechanism includes a lockout tag mounted to the breaker body, wherein the lockout mechanism is configured to allow the breaker mechanism to operate in the ON state, in the OFF state, and in the TRIPPED state with the lockout tag in a normal position relative to the breaker body, and
wherein the lockout mechanism is configured to lock the breaker mechanism in the TRIPPED state with the lockout tag in a locked position relative to the breaker body.

17. The circuit breaker as recited in claim 16, wherein the lockout mechanism is configured to drive the breaker mechanism into the TRIPPED state in passing from the normal position to the locked position.

18. The circuit breaker as recited in claim 17, wherein the breaker mechanism includes:
a solenoid operatively connected to be controlled by the controller; and
an armature and yoke member biased away from the solenoid and operatively connected to be moved toward by the solenoid by activation of the solenoid to reach the TRIPPED state, wherein the lockout tag is configured to force the armature and yoke mechanism toward the solenoid to reach the TRIPPED state without activation of the solenoid as the lockout tag moves from the normal position to the locked position.

19. The circuit breaker as recited in claim 18, further comprising a switch mounted inside the breaker body, wherein the lockout tag is configured to release the switch in the locked position, and wherein the switch is operatively connected to the controller to input a signal to the controller indicative of the locked position of the lockout tag responsive to the lockout tag triggering the switch, wherein the controller is configured to deny movement of the motor with the switch released to prevent movement of the breaker mechanism to the OFF state or to the ON state.

20. The circuit breaker as recited in claim 16, wherein the lockout tag includes a lock receptacle defined in the lockout tag configured to receive a bolt of a lock, and/or wherein the lockout mechanism is isolated from the breaker mechanism such that the movement of the lockout tag can never trigger the ON state or the OFF state.
